(19) United States
(12) Patent Application Publication
(10) Pub. No.: US 2017/0253776 A1
(43) Pub. Date: Sep. 7, 2017

(54) WATER-BASED COMPOSITION

(71) Applicant: HENKEL AG & CO. KGAA, Duesseldorf (DE)

(72) Inventors: Atsushi KAKUDA, Osaka (JP); Yoshio Yoshida, Osaka (JP)

(21) Appl. No.: 15/604,331

(22) Filed: May 24, 2017

Related U.S. Application Data
(63) Continuation of application No. PCT/JP2015/083518, filed on Nov. 24, 2015.

(30) Foreign Application Priority Data
Nov. 25, 2014 (JP) 2014-237363

(51) Int. Cl. C09J 133/08; C09J 7/02; C08L 33/08

(52) U.S. Cl. CPC C09J 133/08; C08L 33/08; C09J 7/0217; C09J 2433/00; C09J 2425/00; C08L 2205/025; C08L 2201/54

(57) ABSTRACT

An object of the present invention is to provide a pressure-sensitive adhesive having excellent adhesive property, facilitating secondary processing of an adhesive product and providing an adhesive product with excellent holding strength to a substrate and adhesion property to a curved surface. The present invention relates to a water-based composition comprising: (A) an aqueous resin emulsion comprising a polymer having a glass transition temperature of −65 to −40° C. and (B) an aqueous resin emulsion comprising a polymer having a glass transition temperature of 20° C. or more, wherein the aqueous resin emulsion has a minimum film-forming temperature of 40° C. or more.

### FIELD OF THE INVENTION

The present invention relates to a water-based composition and a pressure-sensitive adhesive obtained by applying the water-based composition that exhibits sufficient adhesive property to paper and olefin substrates. More specifically, it relates to a pressure-sensitive adhesive used for product labels and tag labels.

### BACKGROUND OF THE INVENTION

Adhesive products such as labels, pressure-sensitive adhesive tape, pressure-sensitive adhesive films, and pressure-sensitive adhesive sheets usually comprise a pressure-sensitive adhesive and a substrate. Pressure-sensitive adhesives are used in production of paper products such as tape, sheets, and labels and in sticking a label to PET bottles and vessels of metal or the like.

In this way, pressure-sensitive adhesives have been used in various adhesive products, but due to increasing concern on global environment problems and safety to human bodies, water-based compositions for pressure-sensitive adhesives containing no organic solvent are attracting attention. Pressure-sensitive adhesives need to have excellent adhesive property to various substrates, such as paper, olefin substrates, and metal.

A technique to improve the adhesive property to a substrate is a method comprising blending an aqueous resin having a low glass transition temperature as a component of a water-based composition for a pressure-sensitive adhesive. When the aqueous resin has a low glass transition temperature, the adhesive property of the pressure-sensitive adhesive is improved, but so-called secondary processing including cutting of an adhesive product such as pressure-sensitive adhesive labels and slitting becomes difficult. If the pressure-sensitive adhesive has extremely high adhesive property, the pressure-sensitive adhesive will adhere to the cutter and the like when the adhesive product is subjected to secondary processing with a cutter and the like. Thus, there exists a need for a pressure-sensitive adhesive that has excellent adhesive property to a substrate and has no adverse effect on processing of adhesive products.

In Japanese Patent Laid-Open No. 2006-016517 and Japanese Patent Laid-Open No. 2009-263494, an aqueous resin that has a low glass transition temperature is used as the main component, and a slight amount of an aqueous resin that has a high glass transition temperature is blended to thereby prepare a water-based composition for a pressure-sensitive adhesive.

The water-based composition for a pressure-sensitive adhesive of Japanese Patent Laid-Open No. 2006-016517 contains (A) an aqueous dispersion of a polymer having a glass transition temperature of 90 to 105° C. and (B) an aqueous dispersion of a polymer having a glass transition temperature of −75 to −45° C. The component (A) and the component (B) are blended in a ratio (A)/(B)=1/99 to 5/85 (based on weight of solid content) ([Claim 1]).

The composition for a pressure-sensitive adhesive of Japanese Patent Laid-Open No. 2009-263494 contains 85 to 95 parts by weight of (A) an acrylic copolymer having a glass transition temperature of −40° C. or less and 5 to 15 parts by weight of (B) an acrylic copolymer having a glass transition temperature of 30° C. or more ([Claim 1]).

The water-based composition for a pressure-sensitive adhesive in both of the literatures contain a resin having a high glass transition temperature to improve the processability of adhesive products, but result in a decrease in the tackiness (adhesive property) instead. Additionally, the pressure-sensitive adhesive is required to have an ability to retain a label or tape to a paper or metal substrate for a long period (holding strength) in addition to the adhesive property. Furthermore, considering that a label or sheet is affixed on a curved-surface or complex-shaped substrate, the pressure-sensitive adhesive is required to have excellent adhesion property to a curved surface.

### SUMMARY OF THE INVENTION

### Technical Problem

The present invention has been achieved to solve the problems described above, and an object thereof is to provide a water-based composition and a pressure-sensitive adhesive obtained by applying the water-based composition to a substrate to form a coating and drying the coating that has excellent adhesive property, facilitates secondary processing of an adhesive product, and has excellent holding strength to a substrate and adhesion property to a curved surface.

### Solution to Problem

As a result of intensive studies to solve the problems described above, the present inventors have found that the adhesive property, holding strength, adhesion property to a curved surface, and secondary processability of a pressure-sensitive adhesive are improved when a composition for the adhesive contains a plurality of aqueous resin emulsions comprising polymers having different glass transition temperatures respectively, with one aqueous resin emulsion comprising a polymer having a high glass transition temperature and the resin emulsion having a minimum film-forming temperature of a predetermined value, thereby completing the present invention.

That is, the present invention and preferred aspects of the present invention are as follows:

1. A water-based composition comprising:
(A) an aqueous resin emulsion comprising a polymer having a glass transition temperature of −65 to −40° C. and
(B) an aqueous resin emulsion comprising a polymer having a glass transition temperature of 20° C. or more, wherein the aqueous resin emulsion has a minimum film-forming temperature of 40° C. or more.

2. The water-based composition according to the item 1, wherein the polymer contained in the aqueous resin emulsion (B) has a glass transition temperature of 20 to 100° C. and the minimum film-forming temperature of the aqueous resin emulsion (B) is 60° C. or more.

3. The water-based composition according to the item 1 or 2, wherein the polymer contained in the aqueous resin emulsion (B) has a glass transition temperature of 20 to 60° C. and the minimum film-forming temperature of the aqueous resin emulsion (B) is 60 to 80° C.

4. The water-based composition according to any of the items 1 to 3, wherein the aqueous resin emulsion (B) is blended in an amount of 5 to 20 parts by weight (based on weight of solid content) to the aqueous resin emulsion (A) of 100 parts by weight (based on weight of solid content).

5. The water-based composition according to any of the items 1 to 4, wherein the aqueous resin emulsion (B) comprises a polymer of monomers including (meth)acrylic acid and/or a (meth)acrylic acid derivative.

6. The water-based composition according to any of the items 1 to 5, wherein a tackifier resin is blended in an amount of 5 parts by weight or less (based on weight of solid content) to 100 parts by weight of the total weight of the aqueous resin emulsion (A) and the aqueous resin emulsion (B) (based on weight of solid content).

7. The water-based composition according to any of the items 1 to 6, wherein the aqueous resin emulsion (B) is obtained by polymerizing polymerizable monomers to prepare prepolymers and further polymerizing the prepolymers.

8. A pressure-sensitive adhesive obtained by applying the water-based composition according to any of the items 1 to 7 to a substrate to form a coating and drying the coating.

9. An aqueous resin emulsion which is a material for a water-based composition, comprising a polymer having a glass transition temperature of 20° C. or more, wherein the aqueous resin emulsion has a minimum film-forming temperature of 40° C. or more.

10. The aqueous resin emulsion according to the item 9, wherein the emulsion comprises a polymer having a glass transition temperature of 20 to 100° C. and has a minimum film-forming temperature of 60° C. or more.

11. The aqueous resin emulsion according to the item 9, wherein the emulsion comprises a polymer having a glass transition temperature of 20 to 60° C. and has a minimum film-forming temperature of 60 to 80° C.

12. An adhesive product comprising the pressure-sensitive adhesive according to the item 8.

### DETAILED DESCRIPTION OF THE INVENTION

### Advantageous Effects of Invention

The pressure-sensitive adhesive of the present invention has excellent adhesive property, facilitates secondary processing of an adhesive product, and has excellent holding strength to a substrate and adhesion property to a curved surface.

A pressure-sensitive adhesive obtained by applying the water-based composition of the present invention can retain a label or sheet to a substrate, even if the substrate is in a curved structure or complex shape, and when the adhesive product is cut with a cutter and the like, the pressure-sensitive adhesive never adheres to the cutter.

### Description of Embodiments

The water-based composition according to the present invention preferably contains (A) an aqueous resin emulsion containing a polymer having a glass transition temperature of −65 to −40° C. (hereinbelow, sometimes referred to as the component (A)); and (B) an aqueous resin emulsion containing a polymer having a glass transition temperature of 20° C. or more, wherein the aqueous resin emulsion has a minimum film-forming temperature of 40° C. or more (hereinbelow, sometimes referred to as the component (B)).

“An aqueous resin emulsion” herein is a dispersion liquid containing both polymer particulates, which are a dispersoid, and an aqueous medium, which is a dispersion medium. The polymer particulates are dispersed in the aqueous medium to form an emulsion (milky liquid, milky turbid substance).

An “aqueous medium” herein means general water such as tap water, distilled water, and ion exchanged water, but may include an organic solvent which is soluble or dispersible in water and has poor reactivity with the raw materials of the emulsion involved in the present invention (for example, monomers).

The component (A) and the component (B) used for the present invention may further contain monomers, oligomers, prepolymers and/or resins and the like soluble or dispersible in water, and may also contain emulsifiers, polymerizable emulsifiers, polymerization reaction initiators, chain extenders and/or various additives and the like, usually used when aqueous resins or water-soluble resins are manufactured as described below.

(A) Aqueous Resin Emulsion

In the present invention, the aqueous resin emulsion (A) contains a polymer having a glass transition temperature of −65 to −40° C. The glass transition temperature of the polymer contained in the component (A) is preferably −60 to −45° C., and particularly preferably −60 to −50° C. Since the glass transition temperature of the polymer contained in the aqueous resin emulsion (A) lies in the range described above, the pressure-sensitive adhesive of the present invention have excellent adhesive property.

The glass transition temperature of the polymer contained in the aqueous resin emulsion (A) is calculated herein from the glass transition temperature of a homopolymer (hereinbelow, also referred to as the “Tg of a homopolymer”) obtained when monomers to be the materials of the polymer are homopolymerized. Considering the Tg of this homopolymer, the mixture ratio of each monomer (parts by weight) is determined. Specifically, the Tg of the polymer contained in the aqueous resin emulsion (A) can be obtained by calculation using the equation (1).

1/Tg=C₁/Tg₁+C₂/Tg₂+ . . . +Cₙ/Tgₙ (1)

wherein Tg is the theoretical Tg of the copolymer, Cₙ is the proportion of the weight of the nth monomer n to be contained in the monomer mixture, Tgₙ is the Tg of the homopolymer of the nth monomer n, and n is the number of the monomers constituting the copolymer and is a positive integer.

As the Tg of the homopolymer of the monomer, the value listed on the literature can be used. An example of such a literature includes “POLYMER HANDBOOK” (the fourth edition; published by John Wiley & Sons, Inc.). As an example, Tgs of the homopolymers of the monomers listed on POLYMER HANDBOOK are shown below.

Methyl methacrylate (hereinbelow, referred to as “MMA,” Tg=105° C.)

n-Butyl acrylate (hereinbelow, referred to as “n-BA,” Tg=−54° C.)

2-Ethylhexyl acrylate (hereinbelow, referred to as “2EHA,” Tg=−70° C.)

Styrene (hereinbelow, referred to as “St,” Tg=100° C.)

Acrylic acid (hereinbelow, referred to as “AA,” Tg=106° C.)

Methacrylic acid (hereinbelow, referred to as “MAA,” Tg=130° C.)

n-Butyl methacrylate (hereinbelow, referred to as “BMA,” Tg=20° C.)

In the present invention, in addition to the monomers described above, the glass transition temperature of a homopolymer of other monomers is also applicable to the equation (1).

Examples of the aqueous resin emulsion (A) include acrylic resin-based emulsions, vinyl acetate resin-based emulsions, vinyl chloride-vinyl acetate copolymer-based emulsions, styrene-butadiene copolymer-based emulsions, ethylene-vinyl acetate copolymer-based emulsions, polyester resin-based emulsions, urethane resin-based emulsions, nylon resin-based emulsions, and polyolefin-based emulsions.

In the present invention, (A) an aqueous resin-based emulsion is preferably an acrylic resin-based emulsion containing an acrylic resin as a dispersoid. Hereinbelow, as an example of the aqueous resin-based emulsion (A), acrylic resin-based emulsions will be described, but it is not intended to limit thereto in the present invention. An acrylic-based resin is a resin obtained by polymerizing monomers including one or more selected from (meth)acrylic acid and/or (meth)acrylic acid derivatives. It should be noted that acrylic acid and methacrylic acid are herein collectively referred to as “(meth)acrylic acid” and that acrylic acid derivatives and methacrylic acid derivatives are collectively referred to as “(meth)acrylic acid derivatives.”

(Meth)acrylic acid or (meth)acrylic acid derivatives are compounds having one or more (meth)acryloyl group(s) and may have two or more (meth)acryloyl groups.

In the present invention, the aqueous resin emulsion (A) preferably contains, as a compound having one or more (meth)acryloyl group(s), a polymer of monomers including (meth)acrylic acid and/or (meth)acrylic acid derivatives represented by the following formula (I);

CH₂═C(R¹)—COOR² formula (I)

wherein R¹ represents hydrogen atom or methyl group, and R² represents hydrogen atom or functional group other than hydrogen atom.

In the case where R² is a hydrogen atom in the above-described formula (I), the compound represented by the formula (I) is (meth)acrylic acid, and in the case where R² is a functional group other than a hydrogen atom, the formula (I) is a (meth)acrylic acid derivative.

In the formula (I), R² is preferably, but not particularly limited to, a hydrogen atom or an alkyl group. Considering a component (B) described below, in the present invention, it is more preferred that the aqueous resin emulsion (A) contains a polymer of monomers including (meth)acrylic acid (that is, R² is a hydrogen atom).

In the formula (I), in the case where R² is an alkyl group, the alkyl group may be a chain or cyclic, and may be a linear-chain or branched-chain. A chain alkyl group preferably has 1 to 20 carbon atoms, and more preferably 1 to 16 carbon atoms. A cyclic alkyl group preferably has 3 to 8 carbon atoms, and more preferably 3 to 6 carbon atoms.

In the formula (I), in the case where R² is a chain alkyl group, examples of R² include a methyl group, an ethyl group, a propyl group, an isopropyl group, a butyl group, an isobutyl group, a pentyl group, a hexyl group, a 2-ethylhexyl group, a heptyl group, an octyl group, a nonyl group, an isononyl group, a decyl group, a lauryl group, a myristyl group, and a cetyl group. In the case where R² is a cyclic alkyl group, examples of R² include a cyclopropyl group, a cyclobutyl group, a cyclopentyl group, and a cyclohexyl group.

As “(meth)acrylic acid derivatives,” (meth)acrylic acid alkyl esters are preferred. Examples specifically include methyl (meth)acrylate, ethyl (meth)acrylate, isopropyl (meth)acrylate, n-propyl(meth)acrylate, n-butyl (meth)acrylate, isobutyl (meth)acrylate, hexyl (meth)acrylate, cyclohexyl (meth)acrylate, 2-ethylhexyl (meth)acrylate, n-octyl (meth)acrylate, isooctyl (meth)acrylate, n-nonyl (meth)acrylate, isononyl (meth)acrylate, decyl (meth)acrylate, lauryl (meth)acrylate, myristyl (meth)acrylate, and cetyl (meth)acrylate. Among these, n-butyl acrylate, 2-ethylhexyl acrylate, and methyl methacrylate are more preferred.

Further examples of “(meth)acrylic acid derivatives” that can be used for the present invention include (meth)acrylic acid esters having an OH group, such as 2-hydroxyethyl (meth)acrylate and 2-hydroxypropyl (meth)acrylate; diesters and monoesters obtained from (meth)acrylic acid and a glycol, such as polyethylene glycol mono(meth)acrylate, ethylene glycol di(meth)acrylate, diethylene glycol di(meth)acrylate, polypropylene glycol mono(meth)acrylate, and acetoacetoxyethyl (meth)acrylate; amide (meth)acrylate, such as amide (meth)acrylate, N-methylolacrylamide, and diacetone acrylamide; and (meth)acrylic acid esters having an epoxy group, such as glycidyl methacrylate and 3,4-epoxycyclohexyl (meth)acrylate.

These (meth)acrylic acid and (meth)acrylic acid derivatives can be used singly or in combination of two or more.

Furthermore, in the present invention, in production of the aqueous resin emulsion (A), other copolymerizable monomers can be used singly or in combination of two or more together with (meth)acrylic acid and/or a (meth)acrylic acid derivative. In this case, the weight of the (meth)acrylic acid and (meth)acrylic acid derivative (the total if both contained) is preferably 80% by weight or more (100% by weight inclusive), based on the total weight of the monomers used for producing the polymer contained in the aqueous resin emulsion (A).

Example of such “other copolymerizable monomers” include monomers having an ethylenic double bond and containing a carboxyl group or acid anhydride, such as crotonic acid, maleic acid, fumaric acid, itaconic acid, citraconic acid, and maleic anhydride; monomers having an ethylenic double bond and containing chlorine or a cyano group, such as vinyl chloride and acrylonitrile; carboxylic acid vinyl esters, such as vinyl acetate, vinyl propionate, t-butyl vinyl esters, and vinyl versatate; aromatic vinyl monomers, such as styrenes; monomers having an ethylenic double bond and containing silicon, such as vinyltrimethoxysilane, vinyltriethoxysilane, vinyltripropoxysilane, vinyltriisopropoxysilane, vinylmethyldiethoxysilane, vinylmethyldipropoxysilane, vinyltris(β-methoxyethoxy)silane, vinyltriacetoxysilane, γ-methacryloxypropyltrimethoxysilane, γ-methacryloxypropyltriethoxysilane, γ-methacryloxypropyltripropoxysilane, γ-methacryloxypropyImethyldimethoxysilane, and γ-methacryloxypropyltris(isopropoxy)silane.

In the present invention, as “other copolymerizable monomers,” a monomer having an ethylenic double bond and containing silicon is preferably included, and particularly, γ-methacryloxypropyltrimethoxysilane and γ-methacryloxypropylmethyldimethoxysilane are preferred.

As an embodiment of the aqueous resin emulsion (A), a polymer of monomers including one or more selected from the group consisting of acrylic acid, n-butyl acrylate, 2-ethylhexyl acrylate, methyl methacrylate, and monomers having an ethylenic double bond and containing silicon is preferred, a copolymer of monomers including two or more of these is more preferred, and a copolymer of a mixture of all these polymerizable monomers is further preferred.

In the present invention, examples of the method for producing (A) an aqueous resin emulsion include a usual emulsion polymerization method (see Chemistry of Polymer Latex, written by Soichi Muroi, pp. 51 to 54, Kobunshi Kankokai, published in 1970) and a forced emulsifying method (see Japanese Patent Publication No. 6-102748). Also, commercial emulsions can be used as the aqueous resin emulsion (A).

The aqueous resin emulsion (A) according to the present invention can be obtained by the known emulsion polymerization method by use of, for example, the (meth)acrylic acid and/or (meth)acrylic acid derivatives aforementioned and other copolymerizable monomers, as required. “Emulsion polymerization” means radical polymerization performed in an aqueous medium by use of an emulsifier. The emulsion (A) according to the present invention can be obtained according to the known procedures of the emulsion polymerization method.

Examples of the procedures of the emulsion polymerization can include, in the case where (meth)acrylic acid and/or a (meth)acrylic acid derivative are/is subjected to emulsion polymerization,

(i) a method for charging and polymerizing the (meth)acrylic acid and/or (meth)acrylic acid derivative and an emulsifier in an aqueous medium,

(ii) a method for continuously or intermittently dropping the (meth)acrylic acid and/or (meth)acrylic acid derivative and an emulsifier in an aqueous medium, and polymerizing them, and

(iii) a method for adding the (meth)acrylic acid and/or (meth)acrylic acid derivative and an emulsifier to water to prepare an emulsified liquid, which is continuously or intermittently dropped in an aqueous medium to thereby polymerize the liquid.

An “emulsifier,” which has an ability to emulsify monomers, forms micelles in emulsion polymerization processes to provide monomers with a site for polymerization, and promotes particle dispersion stability by being fixed on the surface of polymer particles during or after polymerization. Examples of the emulsifier include anionic surfactants, nonionic surfactants, polymer surfactants, and reactive surfactants having double bonds radically polymerizable into one molecule of an emulsifier.

Examples of the “anionic surfactant” include:

alkali metal alkyl sulfates, such as sodium dodecyl sulfate and potassium dodecyl sulfate;

sodium dodecyl polyglycol ether sulfate;

ammonium alkyl sulfates, such as ammonium dodecyl sulfate;

sodium sulfosinoate;

alkyl sulfonates, such as alkali metal salts of sulfonated paraffins and ammonium salts of sulfonated paraffins;

fatty acid salts, such as sodium laurate, triethanolamine oleate, and triethanolamine abietate;

alkylaryl sulfonates, such as sodium dodecylbenzene sulfonate and alkali metal sulfates of alkali phenol hydroxyethylene;

higher alkyl naphthalene sulfonates;

naphthalene sulfonate-formalin condensates;

dialkyl sulfosuccinates;

polyoxyethylene alkyl sulfates; and

polyoxyethylene alkylaryl sulfates.

Examples of the “nonionic surfactant” include:

polyoxyethylene alkyl ethers;

polyoxyethylene alkylaryl ethers;

sorbitan fatty acid esters;

polyoxyethylene sorbitan fatty acid esters;

fatty acid monoglycerides, such as monolaurates of glycerols;

polyoxyethylene-oxypropylene copolymers; and

condensation products of ethylene oxide and an aliphatic amine, amide, or acid.

Examples of the “polymer surfactant” include polyvinyl alcohol.

Examples of the “reactive surfactant” include sulfate ester salts of polyoxyethylene allyl glycidyl nonylphenyl ether (ADEKA REASOAP SE series (trade name), manufactured by Asahi Denka Co., Ltd.), ammonium salts of α-sulfo-ω-(1-(alkoxy)methyl-2-(2-propenyloxy)ethoxy)-poly(oxy-1,2-ethanediyl) (ADEKA REASOAP SR series (trade name), manufactured by Asahi Denka Co., Ltd.), polyoxyethylene(or alkylene)alkyl(or alkenyl)ether sulfate ammonium salts (PD series (trade name), manufactured by Kao Corporation), sulfosuccinate-type reactive active agents (LATEMUL 180 series (trade name), manufactured by Kao Corporation), sodium alkyl allyl sulfosuccinate salts (Eleminol JS-20 (trade name), manufactured by Sanyo Chemical Industries, Ltd.), polyoxyethylene nonylpropenyl phenyl ether sulfate ester ammonium salts (AQUARON HS series (trade name), manufactured by Dai-Ichi Kogyo Seiyaku Co., Ltd.), polyoxyethylene-1-(allyloxymethyl)alkylether sulfate ester ammonium salts (AQUARON KH series (trade name), manufactured by Dai-Ichi Kogyo Seiyaku Co., Ltd.), polyoxyethylene allyl glycidyl nonylphenyl ethers (ADEKA REASOAP NE series (trade name), manufactured by Asahi Denka Co., Ltd.), polyoxyethylene nonyl propenyl ethers (AQUARON RN series (trade name), manufactured by Dai-Ichi Kogyo Seiyaku Co., Ltd.), and α-hydro-ω-(1-(alkoxy)methyl-2-(propenyloxy)ethoxyypoly(oxy-1,2-ethanediyl) (ADEKA REASOAP ER series (trade name), manufactured by Asahi Denka Co., Ltd.).

Also, chain transfer agents can be used to adjust the molecular weight of acrylic resins obtained by radical polymerization. Examples of the “chain transfer agent” include mercaptoethanol, thioglycerol, thioglycolic acid, octyl thioglycolate, methyl mercaptopropionate, and n-dodecyl mercaptan.

In the present invention, the solid content concentration of the aqueous resin emulsion (A) is, but not particularly limited to, preferably 5 to 70% by weight in the component (A). It should be noted that the solid content of the emulsion means a solid content obtained by drying the emulsion at 105° C. for 3 hours.

(B) Aqueous Resin Emulsion

In the present invention, the aqueous resin emulsion (B) comprises a polymer having a glass transition temperature of 20° C. or more and has a minimum film-forming temperature (MFT) of 40° C. or more.

The glass transition temperature of the polymer contained in the aqueous resin emulsion (B) is 20° C. or more, preferably 20 to 100° C., and particularly preferably 20 to 60° C. Since the glass transition temperature of the polymer contained in the aqueous resin emulsion (B) is 20° C. or more, the pressure-sensitive adhesive of the present invention can impart excellent processability to adhesive products. Also in regard to the glass transition temperature of the polymer contained in the component (B), a solid content obtained by drying the emulsion at 105° C. for 3 hours is mentioned. The glass transition temperature is calculated in the same method as for the glass transition temperature of the component (A).

The MFT of the aqueous resin emulsion (B) is 40° C. or more, preferably 60° C. or more, and most preferably 60 to 80° C. When the MFT of the component (B) is 40° C. or more, the pressure-sensitive adhesive of the present invention can further improve the processability of the adhesive product.

It should be noted that the minimum film-forming temperature is herein usually also referred to as MFT and means the lowest temperature at which an emulsion can be dried to be a film. In the present invention, the MFT is a value measured in accordance with the method described in JIS K 6828-2. A heat gradient tester (manufactured by Rigaku Kogyo K.K.) was used as a measuring instrument. The minimum film-forming temperature is usually also referred to as MFT and means the lowest temperature at which an emulsion can be dried to be a film. In the present invention, the MFT is a value measured in accordance with the method described in JIS K 6828-2. A heat gradient tester (manufactured by Rigaku Kogyo K.K.) was used as a measuring instrument.

Also the component (B), as with the component (A), preferably contains a polymer of monomers including (meth)acrylic acid and/or a (meth)acrylic acid derivative. The component (B) may contain, as with the component (A), “other copolymerizable monomers.” In the component (B), the weight of the (meth)acrylic acid and (meth)acrylic acid derivative (the total if both contained) is preferably 80% by weight or more (100% by weight inclusive), based on the total weight of the monomers used for producing the polymer contained in the aqueous resin emulsion (B). However, it is not required that the monomers to be the materials of the component (A) and the monomers to be the materials of the component (B) be the same.

As an embodiment of the aqueous resin emulsion (B), a polymer of monomers including one or more selected from the group consisting of methacrylic acid, n-butyl methacrylate, 2-ethylhexyl acrylate, methyl methacrylate, and monomers having an ethylenic double bond and containing silicon is preferred, a copolymer of a mixture of monomers including two or more of these is more preferred, and a copolymer of a mixture of all these polymerizable monomers is further preferred.

The method for producing the aqueous resin emulsion (B) may be the same as the method for producing the aqueous resin emulsion (A). However, the aqueous resin emulsion (B) may be obtained by polymerizing polymerizable monomers to prepare prepolymers and further polymerizing the prepolymers.

In the present invention, the solid content concentration of the aqueous resin emulsion (B) is, but not particularly limited to, preferably 5 to 70% by weight in the component (B).

In the water-based composition of the present invention, the aqueous resin emulsion (B) is blended in an amount of preferably 5 to 20 parts by weight (based on weight of solid content), particularly preferably 7 to 15 parts by weight, and most preferably 8 to 13 parts by weight to the aqueous resin emulsion (A) of 100 parts by weight (based on weight of solid content).

Since the blending ratio of both the components lies in the above-described range, the pressure-sensitive adhesive of the present invention have a better balance of the adhesive property, holding strength, and adhesion property to a curved surface and can provide adhesive products with more excellent secondary processability (slit processability).

Blending of the components (A) and (B) is conducted by a known method of blending an emulsion, and is not particularly limited as long as the method can allow a water-based composition according to the present invention to be obtained.

In a preferred embodiment of the water-based composition of the present invention, preferably, the component (A) is an aqueous resin emulsion containing a polymer obtained by polymerizing monomers including one or more selected from the group consisting of acrylic acid, n-butyl acrylate, 2-ethylhexyl acrylate, methyl methacrylate, and monomers having an ethylenic double bond and containing silicon, and the component (B) is an aqueous resin emulsion containing a polymer obtained by polymerizing monomers including one or more selected from the group consisting of methacrylic acid, n-butyl methacrylate, 2-ethylhexyl acrylate, methyl methacrylate, and monomers having an ethylenic double bond and containing silicon.

An embodiment of the water-based composition of the present invention most desirably contains:

(A) an aqueous resin emulsion containing a polymer obtained by copolymerizing a mixture of acrylic acid, n-butyl acrylate, 2-ethylhexyl acrylate, methyl methacrylate, and monomers having an ethylenic double bond and containing silicon, and

(B) an aqueous resin emulsion containing a polymer obtained by copolymerizing a mixture of methacrylic acid, n-butyl methacrylate, 2-ethylhexyl acrylate, methyl methacrylate, and monomers having an ethylenic double bond and containing silicon.

A pressure-sensitive adhesive is obtained by applying the water-based composition of the present invention to a substrate to form a coating and drying the coating. The pressure-sensitive adhesive of the present invention has an excellent total balance of adhesive property, holding strength, and adhesion property to a curved surface, and exhibits excellent processability of adhesive products.

The water-based composition of the present invention, further, preferably contains a tackifier resin.

Examples of the “tackifier resin” include rosin resins, terpene resins, terpene-phenol resins, coumarone-indene resins, and petroleum hydrocarbon resins. Examples of the rosin resin include rosin esters and rosin phenols.

The tackifier resins may be commercially available ones, and examples include SUPER ESTER E-730-55, SUPER ESTER E-720, SUPER ESTER 786-60, SUPER ESTER E-650, SUPER ESTER E-865, TAMANOL E-200, TAMANOL E-100, and AM-1002 (manufactured by ARAKAWA CHEMICAL INDUSTRIES, LTD.); and HARIESTER DS-70E, HARIESTER SK-70D, HARIESTER SK-90D-55, HARIESTER SK-508H, HARIESTER SK-816E, and HARIESTER 822E. All the names listed are the trade names.

Also, in these several years, from the viewpoint of increases in environmental awareness, toluene- and xylene-free tackifying resins and solvent-free tackifier resins are preferably used. Examples of such tackifier resins include SUPER ESTER E-865NT, SUPER ESTER E-625NT, SUPER ESTER NS-100H, SUPER ESTER NS-121, and TAMANOL E-200NT (manufactured by ARAKAWA CHEMICAL INDUSTRIES, LTD.); and HARIESTER SK-218NS, HARIESTER SK-323NS, HARIESTER SK-370N, HARIESTER SK-501NS, and HARIESTER SK-385NS (manufactured by Harima Chemicals Group, Inc.). All the names listed are the trade names.

In the present invention, the amount of the tackifier resin to be added can be 5 parts by weight or less (based on weight of solid content) relative to 100 parts by weight of the total weight of the component (A) and the component (B) (based on weight of solid content). Since the amount of the tackifier resin to be added is decreased, the pressure-sensitive adhesive of the present invention has no decrease in the adhesive property to olefin substrates and the like, can maintain the holding strength, and exhibits further improved processability of adhesive products.

The water-based composition of the present invention can further contain as additives, plasticizers, antifoaming agents, thickeners, waxes, preservatives, colorants, fillers, and the like, as required and as appropriate. These additives may be mixed after mixing the component (A) and the component (B), or may be premixed into either of the component (A) or the component (B).

Examples of the “plasticizer” include glycerin; polyhydric alcohols, such as ethylene glycol and propylene glycol; polyesters, such as adipic acid, benzoic acid, acetylcitric acid, alkyl sulfonic acid, and phthalic acid polyesters; sugars, such as sucrose and sorbitol; and organic solvents, such as cellosolves.

Examples of the “antifoaming agent” include:

silicone-based antifoaming agents, such as dimethyl polysiloxane, polyoxyalkylene modified silicones, organic modified polysiloxanes, and fluorine silicones;

oils and fats-based antifoaming agents, such as castor oil, sesame oil, linseed oil, and animal and plant oils;

fatty acid-based antifoaming agents, such as stearic acid, oleic acid, and palmitic acid;

fatty acid ester-based antifoaming agents, such as isoamyl stearate, diglycol laurate, distearyl succinate, distearic acid, sorbitan monolaurate, glycerin fatty acid esters, polyoxyethylene sorbitan, butyl stearate monolaurate, sucrose fatty acid esters, ethyl acetate alkyl esters of sulfonated ricinoleic acid, and natural waxes;

alcohol-based antifoaming agents, such as polyoxyalkyleneglycol and its derivatives, polyoxyalkylene alcohol hydrate, diamylphenoxy ethanol, 3-heptanol, and 2-ethylhexanol;

ether-based antifoaming agents, such as 3-heptylcellosolve and nonylcellosolve-3-heptylcarbitol;

phosphate ester-based antifoaming agents, such as tributyl phosphate, sodium octyl phosphate, and tris(butoxyethyl)phosphate;

amine-based antifoaming agents, such as diamyl amine;

amide-based antifoaming agents, such as polyalkyleneamide, acylate polyamine, and dioctadecanoyl piperidine;

metal soap-based antifoaming agents, such as aluminum stearate, calcium stearate, potassium oleate, and calcium salts of wool olein;

sulfonate ester-based antifoaming agents, such as sodium lauryl sulfonate and sodium dodecyl sulfonate; and

hydrophobic silica-based antifoaming agents; and mineral oil-based antifoaming agents.

Examples of the “thickener” include:

natural polymer-based thickeners, such as gelatin, casein, alginic acid, propyleneglycol alginate, triethanolamine alginate, ammonium alginate, sodium alginate, guar gum, gellan gum, xanthan gum, Welan gum, ethylcellulose, hydroxyethylcellulose, methylcellulose, carboxymethylcellulose, hydroxypropylcellulose, and hydroxypropylmethylcellulose;

polyvinyl-based thickeners, such as polyvinyl alcohol, polyvinylpyrrolidone, and polyvinyl benzyl-ether copolymers;

poly(meth)acrylic acid-based thickeners, such as sodium polyacrylate, acrylic acid-(meth)acrylate copolymers, sodium polymethacrylate, methacrylic acid-(meth)acrylate copolymers, modified polyacrylic acid sulfonate, modified polymethacrylic acid sulfonate, styrene-acrylic acid copolymers, styrene-acrylic acid-(meth)acrylate copolymers, styrene-methacrylic acid copolymers, styrene-methacrylic acid-(meth)acrylate copolymers;

polyether-based thickeners, such as Pluronic polyethers, polyether dialkyl esters, urethane-modified polyethers, polyether dialkyl ethers, and epoxy-modified polyethers;

itaconic acid-based thickeners, such as polyitaconic acid, itaconic acid-(meth)acrylate copolymers, itaconic acid-maleic acid copolymers, itaconic acid-acrylic acid copolymers, and itaconic acid-methacrylic acid copolymers;

maleic anhydride-based thickeners, such as maleic anhydride-(meth)acrylate copolymers, maleic anhydride-acrylonitrile copolymers, maleic anhydride-vinyl acetate copolymers, and partial esters of vinyl methyl ether-maleic anhydride copolymers; and

higher fatty-based acid amide thickeners.

A filler is a substance to be added for improving performance and reducing costs, and is not particularly limited as long as the filler is one usually recognized as a filler. Specific examples include calcium carbonate, magnesium carbonate, silica, talc, clay, and alumina.

In producing the water-based composition of the present invention, the component (A) and the component (B) are mixed, and the above-described additives are preferably mixed as required. “Mixing” is a method usually used for mixing resin compositions, and is not particularly limited as long as the water-based composition according to the present invention can be obtained by the method.

The viscosity (30° C., solid content concentration: 55% by weight) of the water-based composition according to the present invention is preferably 2000 to 5000 mPa·s, more preferably 2000 to 4500 mPa·s, and particularly preferably 2000 to 4000 mPa·s, when measured with a B type rotary viscometer. Since the viscosity lies in the above-described range, the water-based composition of the present invention becomes easy to apply in producing an adhesive product.

Since the water-based composition for a pressure-sensitive adhesive comprises both components, the aqueous resin emulsion (A) and the aqueous resin emulsion (B) and, in some cases, contains the above-described additives, the pressure-sensitive adhesive of the present invention has excellent adhesive property, holding strength, and adhesion property to a curved surface and can improve the secondary processability of adhesive products.

The adhesive product according to the present invention comprises the above-described pressure-sensitive adhesive. The adhesive product may be a product in which an adherend is affixed to a substrate with the above-described pressure-sensitive adhesive or may be a product having the pressure-sensitive adhesive on an adherend or a substrate and being ready to be affixed to the substrate or the adherend. The water-based composition may be applied on the substrate or the adherend. Examples of the adherend material include paper and plastics. Examples of the form of the adherend include sheets, films, and labels. As the substrate, paper, plastics, metals, glass, non-woven fabric, and the like are used.

Examples of the adhesive product of the present invention include so-called pressure-sensitive adhesive tape, pressure-sensitive adhesive sheets, pressure-sensitive adhesive films, and pressure-sensitive adhesive labels. Specific examples include pressure-sensitive adhesive films and protective films for the electronics field, such as back grinding tape and dicing tape for semiconductor wafers, protection tape for transferring electronic parts, and protection tape for printed circuit boards; for the automobile field, such as protection films for window panes, films for baking finishing, guard films for protecting an automobile until delivery to a user, marking films for indication, marking films for ornamentation, and sponge tape for buffering, protection, heat insulation, and sound proofing; for the medical and hygiene material field, such as plasters and transdermal absorption patches; for electric insulation; for discrimination; for duct work; for protecting window panes; for covering; for wrapping; for packaging; for business use; for domestic use; for fixing; for binding; and for repairing.

The method for producing an adhesive product is not particularly limited. The water-based composition can be applied on the substrate or adherend of the adhesive product in a usual method, followed by affixing the two each other. Specifically, the water-based composition of the invention can be applied using various coating apparatuses, such as comma coaters, reverse coaters, slot die coaters, lip coaters, gravure chamber coaters, and curtain coaters on a paper or plastic film substrate, or a peelable sheet and dried to thereby obtain various adhesive products such as pressure-sensitive adhesive sheets and pressure-sensitive adhesive labels.

The amount of the water-based composition is preferably 5 to 100 g/m², more preferably 5 to 50 g/m², and particularly preferably 10 to 20 g/m² as a solid content. Here, the solid content of the water-based composition means a solid content obtained by drying the water-based composition at 105° C. for 3 hours.

It should be noted that the following embodiments of the present invention are also preferable.

(Additional aspect 1) A water-based composition comprising:

a first resin that has a glass transition temperature of −65 to −40° C. and is a polymer of polymerizable monomers including one or more selected from the group consisting of acrylic acid, n-butyl acrylate, 2-ethylhexyl acrylate, methyl methacrylate, and a monomer having an ethylenic double bond and containing silicon; and

a second resin that has a glass transition temperature of 20° C. or more and is a polymer of polymerizable monomers including one or more selected from the group consisting of methacrylic acid, n-butyl methacrylate, 2-ethylhexyl acrylate, methyl methacrylate, and a monomer having an ethylenic double bond and containing silicon.

(Additional aspect 2) The water-based composition according to the additional aspect 1, further comprising 5 parts by weight or less of a tackifier resin based on the total weight of the first resin and the second resin.

It should be noted that the tackifier resin is preferably contained in an amount of 5 parts by weight or less, more preferably contained in an amount of more than 0 parts by weight and 5 parts by weight or less based on the total weight of the first resin and the second resin.

(Additional aspect 3) The water-based composition according to the additional aspect 1 or 2, wherein at least one of the first resin and the second resin has a structural unit on the basis of the monomer having an ethylenic double bond and containing silicon.

### EXAMPLES

Hereinbelow, Examples of the present invention are described in detail, but these Examples are merely aspects of the present invention, and the present invention is not intended to be limited to these Examples in any way.

A water-based composition according to the present invention was prepared from (A) an aqueous resin emulsion (a component (A)) and an aqueous resin emulsion (B) (a component (B)). Polymerizable monomers to be the materials of the components (A) and (B) and each additive are described hereinbelow. It should be noted that, in Tables 1 to 4, any numerical value representing the amount of each component blended is parts by weight based on solid content.

<Polymerizable Monomer>

The polymerizable monomers to be the materials of the component (A) and the component (B) are shown below. It should be noted that the homopolymer Tg of the polymerizable monomers is the value calculated with the previously-described theoretical calculation formula.

Styrene (hereinbelow, referred to as “St”) (manufactured by Wako Pure Chemical Industries, Ltd., Tg=100° C.)

Methyl methacrylate (hereinbelow, referred to as “MMA”) (manufactured by Wako Pure Chemical Industries, Ltd., Tg=105° C.)

n-Butyl methacrylate (hereinbelow, referred to as “n-BMA”) (manufactured by Wako Pure Chemical Industries, Ltd., Tg=20° C.)

Methyl acrylate (hereinbelow, referred to as “MA”) (manufactured by Wako Pure Chemical Industries, Ltd., Tg=8° C.)

Acrylic acid (hereinbelow, referred to as “AA”) (manufactured by Wako Pure Chemical Industries, Ltd., Tg=106° C.)

Methacrylic acid (hereinbelow, referred to as “MAA”) (manufactured by Wako Pure Chemical Industries, Ltd., Tg=130° C.)

n-Butyl acrylate (hereinbelow, referred to as “n-BA”) (manufactured by Wako Pure Chemical Industries, Ltd., Tg=−54° C.)

2-Ethylhexyl acrylate (hereinbelow, referred to as “2EHA”) (manufactured by Wako Pure Chemical Industries, Ltd., Tg=−70° C.)

3-Methacryloxypropyltrimethoxysilane (hereinbelow, “SZ-6030”)

γ-Methacryloxypropylmethyldimethoxysilane (hereinbelow, referred to as “Y9910”)

<Production Example of (A) an Aqueous Resin Emulsion>

Synthesis of (A1) an Aqueous Resin Emulsion

As shown in Table 1, 86 parts by weight of 2EHA, 12.7 parts by weight of MA, and 1.3 parts by weight of AA were homogeneously mixed to prepare a monomer solution. To a homogeneously mixed solution of 18.8 parts by weight of water and 1.0 part by weight of AQUARON KH10 (trade name) manufactured by Dai-Ichi Kogyo Seiyaku Co., Ltd., the monomer solution was added, and these mixed solutions were stirred using a stirrer to thereby prepare a pre-emulsion.

To a reactor equipped with a stirrer, a condenser, and a thermometer, 42 parts by weight of water and 0.14 parts by weight of AQUARON KH10 were added, the system was purged with nitrogen gas, and then, the solution added was heated to 80° C. Subsequently, to the solution added, 2 parts by weight of a 3% by weight ammonium persulfate (hereinbelow, also referred to as “APS”) aqueous solution was added.

After additional 10 minutes, while the temperature in the reactor was maintained at 80° C., the above-described pre-emulsion and 8 parts by weight of the 3% by weight APS aqueous solution, which is a polymerization catalyst, were each added dropwise simultaneously over 3 hours. While the temperature in the reactor was maintained at 80° C., 1 hour after the dropwise addition was finished, 2.4 parts by weight of the 3% by weight APS aqueous solution was added to the reactor, and stirring was continued for additional 2 hours to thereby obtain (A1) an aqueous resin emulsion. To the aqueous resin emulsion (A1), ammonia water was added to adjust the pH of (A1) to 7.

The aqueous resin emulsion (A1) comprised a polymer having a glass transition temperature of -61° C. and had a solid content concentration of 58% by weight. The solid content is the percentage by weight of a residual portion after drying in an oven at 105° C. for 3 hours to the weight before drying.

Synthesis of (A2) to (A′5) Aqueous Resin Emulsions

(A2) to (A′5) aqueous resin emulsions were synthesized in the same method as for (A1), except that material monomers were used as shown in Table 1. The compositions of the polymerizable monomers in synthesizing (A2) to (A′5), the glass transition temperatures of the polymers, and the solid content concentrations of the aqueous emulsions obtained are shown in Table 1.

TABLE 1

| | | (A) aqueous resin emulsion | | | | |
|---|---|---|---|---|---|---|
| | | A1 | A2 | A3 | A′4 | A′5 |
| Polymerizable | AA | 1.3 | 0.6 | 0.6 | 0.6 | 0.6 |
| monomer | MMA | | 2.4 | 18 | | 22.4 |
| (parts by weight) | MA | 12.7 | | | | |
| | n-BA | | 73.0 | 57.4 | | 53.0 |
| | 2EHA | 86.0 | 24 | 24 | 99.4 | 24 |
| | SZ-6030 | | 0.03 | 0.03 | 0.03 | 0.03 |

| | | | | | |
|---|---|---|---|---|---|
| glass transition temperature | −61 | −55 | −40 | −69 | −35.5 |
| (° C.) | | | | | |
| solid content (% by weight) | 58 | 58 | 58 | 58 | 58 |

<Production Example of (B) an Aqueous Resin Emulsion>

Synthesis of (B1) an Aqueous Resin Emulsion

As shown in Table 2, 67.6 parts by weight of St, 10.0 parts by weight of MMA, 19.9 parts by weight of 2EHA, and 2.5 parts by weight of MAA were homogeneously mixed to prepare a monomer solution.

To a homogeneously mixed solution of 25.2 parts by weight of water, 3.3 parts by weight of NOIGEN EA177 (trade name) manufactured by Dai-Ichi Kogyo Seiyaku Co., Ltd., and 1.0 part by weight of PELEX OT-P (trade name) manufactured by Kao Corporation, the monomer solution was added, and these mixed solutions were stirred using a stirrer to thereby prepare a pre-emulsion.

To a reactor equipped with a stirrer, a condenser, and a thermometer, 51.6 parts by weight of water and 0.3 parts by weight of NOIGEN EA177 were added, the system was purged with nitrogen gas, and then, the solution added was heated to 80° C.

To the solution added, 3.2 parts by weight of the pre-emulsion was added, and after 10 minutes, 0.4 parts by weight of a 5% by weight sodium persulfate (hereinbelow, also referred to as “SPS”) aqueous solution was added thereto.

After additional 20 minutes, while the temperature in the reactor was maintained at 80° C., the remaining pre-emulsion and 8.4 parts by weight of the 3% SPS aqueous solution, which is a polymerization catalyst, were each added dropwise simultaneously over 4 hours. While the temperature in the reactor was maintained at 80° C., 1 hour after the dropwise addition was finished, 2.8 parts by weight of the 3% SPS aqueous solution was added to the reactor, and stirring was continued for additional 2 hours to thereby obtain (B1) an aqueous resin emulsion.

The aqueous resin emulsion (B1) comprised a polymer having a glass transition temperature of 48° C., had a solid content concentration of 54% by weight, and had a minimum film-forming temperature (MFT) of 75° C. The solid content is the percentage by weight of a residual portion after drying in an oven at 105° C. for 3 hours to the weight before drying. The MFT was measured in accordance with the method described in JIS K 6828-2, and taken as the lowest temperature at which the emulsion was dried to form a continuous membrane using a heat gradient tester (manufactured by Rigaku Kogyo K.K.).

Synthesis of (B2) an Aqueous Resin Emulsion

As shown in Table 2, 18 parts by weight of MMA, 20 parts by weight of BMA, 11 parts by weight of 2EHA, 1.1 parts by weight of MAA, and 0.1 parts by weight of Y9910 were homogeneously mixed to prepare a monomer solution. To a homogeneously mixed solution of 18 parts by weight of water and 0.9 parts by weight of AQUARON KH10 (trade name) manufactured by Dai-Ichi Kogyo Seiyaku Co., Ltd., the monomer solution (b1) was added, and these mixed solutions were stirred using a stirrer to thereby prepare a pre-emulsion 1.

Homogeneously mixed were 27.5 parts by weight of MMA, 20 parts by weight of BMA, 1.5 parts by weight of 2EHA, 0.9 parts by weight of MAA, and 0.1 parts by weight of Y9910 to prepare a monomer solution (b2). To a homogeneously mixed solution of 18 parts by weight of water and 0.9 parts by weight of AQUARON KH10 (trade name) manufactured by Dai-Ichi Kogyo Seiyaku Co., Ltd., the monomer solution (b2) was added, and these mixed solutions were stirred using a stirrer to thereby prepare a pre-emulsion 2.

To a reactor equipped with a stirrer, a condenser, and a thermometer, 56 parts by weight of water and 0.2 parts by weight of AQUARON KH10 were added, the system was purged with nitrogen gas, and then, the solution added was heated to 80° C. Subsequently, to the solution, 12 parts by weight of the pre-emulsion 1 was added, and after 10 minutes, 2.8 parts by weight of a 1% by weight sodium persulfate (hereinbelow, also referred to as “SPS”) aqueous solution was added thereto. After additional 20 minutes, the remaining pre-emulsion 1 was added dropwise over 2 hours, and 1 hour after the dropwise addition of the pre-emulsion 1 was finished, the pre-emulsion 2 was added dropwise over 2 hours.

Simultaneously with when the dropwise addition of the pre-emulsion 1 was started, dropwise addition of a 3% by weight SPS aqueous solution, which is a polymerization catalyst, was started. For 5 hours until the dropwise addition of the pre-emulsion 2 was finished, 4.2 parts by weight of the 3% by weight SPS aqueous solution was added dropwise.

After the dropwise addition was finished, the temperature in the reactor was maintained at 80° C., after 1 hour, 2.8 parts by weight of the 3% by weight SPS aqueous solution was added into the reactor, and stirring was continued for additional 2 hours to thereby obtain (B2) an aqueous resin emulsion. The aqueous resin emulsion (B2) comprised a polymer having a glass transition temperature of 36° C., had a minimum film-forming temperature (hereinbelow, also referred to as MFT) of 65° C., and had a solid content of 50% by weight.

Synthesis of (B3) to (B′5) Aqueous Resin Emulsions

(B3) to (B′5) aqueous resin emulsions were synthesized in the same method as for (B1), except that material monomers were used as shown in Table 2. The compositions of the polymerizable monomers in synthesizing (B3) to (B′5) are shown in Table 2.

TABLE 2

| | | | (B) aqueous resin emulsion | | | | |
|---|---|---|---|---|---|---|---|
| | | | B1 | B2 | B3 | B′4 | B′5 |
| Polymerizable | (b1) | St | 67.6 | | | | |
| monomers | | MMA | 10.0 | 18 | 94.0 | 64.5 | 37.5 |
| (parts by | | MAA | 2.5 | 1.1 | 3.0 | 2.0 | 2.0 |
| weight) | | BMA | | 20 | | | |
| | | n-BA | | | | | |
| | | 2EHA | 19.9 | 11 | 3.0 | 33.5 | 60.5 |
| | | Y9910 | | 0.1 | | | |
| | (b2) | MMA | | 27.5 | | | |
| | | MAA | | 0.9 | | | |
| | | BMA | | 20 | | | |
| | | 2EHA | | 1.5 | | | |
| | | Y9910 | | 0.1 | | | |

| | | | | | |
|---|---|---|---|---|---|
| glass transition temperature | 48 | 36 | 96 | 21 | −24 |
| (° C.) | | | | | |
| solid content (% by weight) | 54 | 50 | 50 | 50 | 50 |
| minimum film-forming | 75 | 65 | >100 | 30 | <0 |
| temperature (MFT) (° C.) | | | | | |

<Preparation of a Water-Based Composition>

Water-based composition of Example 1 to Example 11 and Comparative Example 1 to Comparative Example 10 were prepared as follows.

To 100 parts by weight of the aqueous resin emulsion (A) (based on solid content), the aqueous resin emulsion (B), a tackifier (manufactured by ARAKAWA CHEMICAL INDUSTRIES, LTD., SUPER ESTER E730-55 (trade name)), and calcium carbonate (manufactured by MARUO CALCIUM CO., LTD., SUPER #2000 (trade name)) were blended as shown in Table 3 and Table 4 with a mechanical stirrer (manufactured by TOKYO RIKAKIKAI CO., LTD.) to prepare a water-based composition.

<Preparation of an Evaluation Sample>

The water-based composition was applied with a table coater on release paper such that the amount of coating after drying was 20 g/m². After dried in an oven for 3 minutes in an atmosphere at 105° C., good quality paper was affixed to the release paper to prepare a label-type evaluation sample. By using this evaluation sample, the adhesive property, holding strength, adhesion property to a curved surface, and slittability were evaluated. The evaluation method and evaluation criteria are shown below.

<Adhesive Property>

A stainless steel plate (30 mm×100 mm×15 mm) having a surface polished in advance and a polypropylene plate (30 mm×100 mm×15 mm) having a surface defatted with isopropyl alcohol were left still under conditions of 23° C. and 5° C. for 1 hour or more, onto these, the above-described evaluation sample was affixed, and the adhesive property of the pressure-sensitive adhesives was evaluated.

The evaluation sample was cut into strips having a width of 25 mm, and after the release paper was removed, the sample was each affixed onto the stainless steel plate and the polypropylene plate. 30 minutes after the affixation, the sample was peeled off in a direction of 180° at a peeling speed of 300 mm/minute on a slow-strain-rate universal testing machine (manufactured by JT Toshi), and the strength on peeling was measured. The evaluation criteria are shown below.

∘∘: The peeling strength was 15 N/25 mm or more, and the good quality paper of the evaluation sample was broken.

∘: The peeling strength was 15 N/25 mm or more, and peeling occurred at the interface between the plate and the pressure-sensitive adhesive.

Δ: The peeling strength was less than 15 N/25 mm, and peeling occurred at the interface between the plate and the pressure-sensitive adhesive.

×: There occurred zipping, transfer of the pressure-sensitive adhesive layer onto the plate, or partial cohesive failure of the pressure-sensitive adhesive layer.

<Holding Strength>

The evaluation sample was affixed onto a stainless steel plate having a surface polished in advance, and the sample and plate were pressure-bonded with a roll so as to apply a pressure of 2 kgw on an affixing area of 25 mm×25 mm. This pressure-bonded product was left still under conditions of a temperature of 40° C. and a humidity of 50% for 1 hour. A weight of 1 kg was hung under the adhesion surface in the vertical direction to apply a load of 1 kg on the sample, which was left under conditions of temperature of 40° C. The time for this weight to drop (minutes) was measured to thereby evaluate the holding strength of the pressure-sensitive adhesive. The evaluation criteria are shown below.

∘∘: After 1440 minutes have passed, the weight does not drop, and the affixing position is not displaced.

∘: After 1440 minutes have passed, the weight does not drop, and the affixing position is displaced.

Δ: After 720 minutes or more and less than 1440 minutes, the weight drops.

×: After less than 720 minutes, the weight drops.

<Adhesion Property to a Curved Surface>

Under conditions of 23° C., a polypropylene rod having a diameter of 8 mm and a length of 150 mm and the evaluation sample were left still, and the evaluation sample was cut into a width of 20 mm and a length of 15 mm. After the release paper was removed, the evaluation sample was affixed onto the polypropylene rod. The release paper was firmly pressed with a finger to pressure-bond the sample onto the rod, and the pressure-bonded product was left still at 23° C. for 24 hours. Section paper was interposed into either side of this pressure-bonded product, and the lengths of lifting and peeling were measured. Measurement was performed on three samples, and the average of the calculated values was used to evaluate the adhesion property to a curved surface.

∘∘: The peeling is less than 0.5 mm.

∘: The peeling is 0.5 mm or more and less than 1.0 mm.

Δ: The peeling is 1.0 mm or more and less than 2.0 mm.

×: The peeling is 2.0 mm or more.

<Slittability>

Under conditions of 23° C., the evaluation sample and commercially available hand slitter were left still for 1 hour or more. After the evaluation sample was cut into a length of 300 mm with a slit blade, which had been weighed in advance, the blade was weighed again, and the change in the weight before and after cutting was taken as the amount of the pressure-sensitive adhesive attached.

∘∘: The amount of the pressure-sensitive adhesive attached is less than 0.5 mg.

∘: The amount of the pressure-sensitive adhesive attached is 0.5 mg or more and less than 1.0 mg.

Δ: The amount of the pressure-sensitive adhesive attached is 1.0 mg or more and less than 2.0 mg.

×: The amount of the pressure-sensitive adhesive attached is 2.0 mg or more.

TABLE 3

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| aqueous | (A1) | 100 | 100 | 100 | 100 | 100 | | | | | | |
| resin | (A2) | | | | | | 100 | 100 | 100 | | | |
| emulsion (A) | (A3) | | | | | | | | | 100 | 100 | 100 |
| (parts by | | | | | | | | | | | | |
| weight) | | | | | | | | | | | | |
| aqueous | (B1) | 10.0 | 15.0 | | | | 12.4 | | | 10.3 | | |
| resin | (B2) | | | 5.0 | 9.6 | | | 8.6 | | | 9.6 | |
| emulsion (B) | (B3) | | | | | 9.6 | | | 9.6 | | | 9.6 |
| (parts by | | | | | | | | | | | | |
| weight) | | | | | | | | | | | | |
| SUPER ESTER | | 5.3 | 5.6 | 5.0 | 5.3 | 5.3 | 5.3 | | 5.3 | 5.3 | 5.3 | 5.3 |
| E730-55 | | | | | | | | | | | | |
| (parts by weight) | | | | | | | | | | | | |
| calcium carbonate | | 3.8 | 4.1 | 3.6 | 3.8 | 3.8 | 3.8 | | 3.8 | 3.8 | 3.8 | 3.8 |
| SUPER #2000 | | | | | | | | | | | | |
| (parts by weight) | | | | | | | | | | | | |
| Adhesive | SUS | ∘∘ | ∘∘ | ∘∘ | ∘∘ | ∘∘ | ∘∘ | ∘∘ | ∘∘ | ∘∘ | ∘∘ | ∘∘ |
| property | PP | ∘ | ∘∘ | ∘∘ | ∘∘ | ∘∘ | ∘∘ | ∘∘ | ∘∘ | ∘∘ | ∘∘ | ∘∘ |
| (5° C.) | | | | | | | | | | | | |
| Adhesive | SUS | ∘∘ | ∘∘ | ∘∘ | ∘∘ | ∘∘ | ∘∘ | ∘∘ | ∘∘ | ∘∘ | ∘∘ | ∘∘ |
| property | PP | ∘∘ | ∘∘ | ∘ | ∘∘ | ∘∘ | ∘∘ | ∘∘ | ∘∘ | ∘∘ | ∘∘ | ∘∘ |
| (23° C.) | | | | | | | | | | | | |

| | | | | | | | | | | | |
|---|---|---|---|---|---|---|---|---|---|---|---|
| Holding strength | ∘∘ | ∘∘ | ∘ | ∘∘ | ∘∘ | ∘∘ | ∘∘ | ∘∘ | ∘ | ∘∘ | ∘∘ |
| Adhesion property to | ∘ | ∘ | ∘ | ∘ | ∘ | ∘∘ | ∘∘ | ∘ | ∘ | ∘ | ∘ |
| a curved surface | | | | | | | | | | | |
| Slittability | ∘ | ∘ | ∘ | ∘ | ∘ | ∘∘ | ∘∘ | ∘ | ∘ | ∘ | ∘ |

SUS: Adhesive property to a stainless steel plate
PP: Adhesive property to a polypropylene plate

TABLE 4

| | | Comparative Example | | | | | | | | | |
|---|---|---|---|---|---|---|---|---|---|---|---|
| | | 1 | 2 | 3 | 4 | 5 | 6 | 7 | 8 | 9 | 10 |
| aqueous | (A1) | 100 | 100 | | | | | | | | |
| resin | (A2) | | | 100 | 100 | 100 | | | | | |
| emulsion (A) | (A′4) | | | | | | 100 | 100 | | | |
| (parts by | (A′5) | | | | | | | | 100 | 100 | 100 |
| weight) | | | | | | | | | | | |
| aqueous | (B1) | | | | | | 10.3 | | | 10.3 | |
| resin | (B3) | | | | | | | 9.6 | | | 9.6 |
| emulsion (B) | (B′4) | 9.6 | | | 9.6 | | | | | | |
| (parts by | (B′5) | | 9.6 | | | 9.6 | | | | | |
| weight) | | | | | | | | | | | |
| SUPER ESTER | | 5.3 | 5.3 | 4.7 | 5.3 | 5.3 | 5.3 | 5.3 | 4.7 | 5.3 | 5.3 |
| E730-55 | | | | | | | | | | | |
| (parts by weight) | | | | | | | | | | | |
| calcium carbonate | | 3.8 | 3.8 | 3.4 | 3.8 | 3.8 | 3.8 | 3.8 | 3.4 | 3.8 | 3.8 |
| SUPER #2000 | | | | | | | | | | | |
| (parts by weight) | | | | | | | | | | | |
| Adhesive | SUS | Δ | ∘ | ∘∘ | ∘∘ | Δ | Δ | Δ | x | x | x |
| property | PP | ∘ | x | ∘∘ | x | x | ∘ | Δ | x | x | x |
| (5° C.) | | | | | | | | | | | |
| Adhesive | SUS | Δ | Δ | ∘∘ | ∘ | Δ | x | Δ | x | x | x |
| property | PP | ∘ | ∘ | Δ | x | Δ | x | ∘ | x | x | x |
| (23° C.) | | | | | | | | | | | |

| | | | | | | | | | | |
|---|---|---|---|---|---|---|---|---|---|---|
| Holding strength | x | x | x | x | x | x | x | x | x | x |
| Adhesion property to | Δ | Δ | Δ | Δ | Δ | x | Δ | x | x | x |
| a curved surface | | | | | | | | | | |
| Slittability | Δ | x | x | Δ | x | Δ | x | x | Δ | ∘ |

SUS: Adhesive property to a stainless steel plate
PP: Adhesive property to a polypropylene plate

As shown in Table 3, the pressure-sensitive adhesives of Examples, which contain both the component (A) and the component (B), have excellent adhesive property, holding strength, adhesion property to a curved surface, and slittability, having an excellent total balance. In particular, the pressure-sensitive adhesives of Examples 6 to 8 have greatly improved above-described performance because of having the component (A2).

Any of the adhesive property, holding strength, adhesion property to a curved surface, and slittability of the pressure-sensitive adhesives of Comparative Examples is rated as x because the adhesives do not contain one of the component (A) and the component (B) as shown in Table 4.

### INDUSTRIAL APPLICABILITY

The present invention can provide a water-based composition. The water-based composition according to the present invention is applied on paper, plastics, metal, or the like to thereby obtain adhesive products referred to as pressure-sensitive adhesive tape, pressure-sensitive adhesive sheets, and pressure-sensitive adhesive labels.

1. A water-based composition comprising:
(A) a first aqueous resin emulsion comprising a polymer having a glass transition temperature of −65 to −40° C. and
(B) a second aqueous resin emulsion comprising a polymer having a glass transition temperature of 20° C. or more, wherein the second aqueous resin emulsion has a minimum film-forming temperature of 40° C. or more.

2. The water-based composition according to claim 1, wherein the polymer contained in the second aqueous resin emulsion (B) has a glass transition temperature of 20 to 100° C. and the minimum film-forming temperature of the aqueous resin emulsion (B) is 60° C. or more.

3. The water-based composition according to claim 1, wherein the second aqueous resin emulsion (B) is blended in an amount of 5 to 20 parts by weight (based on weight of solid content) to the first aqueous resin emulsion (A) of 100 parts by weight (based on weight of solid content).

4. A pressure-sensitive adhesive obtained by applying the water-based composition according to claim 1 to a substrate to form a coating and drying the coating.

5. An adhesive product comprising the pressure-sensitive adhesive according to claim 1.

6. A method of forming a pressure-sensitive adhesive by:
(1) applying the water-based adhesive according to claim 1 to a substrate to form a coating; and
(2) drying the coating.
